(19) United States
(12) Patent Application Publication
(10) Pub. No.: US 2026/0176928 A1
(43) Pub. Date: Jun. 25, 2026

(54) DEVICE FOR SUPPLYING COOLANT, AND COOLING WATER SYSTEM

(71) Applicant: Klaus Guenther GmbH, Sinsheim-Steinsfurt (DE)

(72) Inventor: Christian Guenther, Heilbronn (DE)

(21) Appl. No.: 19/127,653

(22) PCT Filed: Oct. 19, 2023
(86) PCT No.: PCT/DE2023/200213

§ 371 Date: May 6, 2025

(30) Foreign Application Priority Data
Nov. 21, 2022 (DE) 10 2022 212 407.3

(51) Int. Cl. E21B 19/16; F01P 7/14

(52) U.S. Cl. CPC E21B 19/165; F01P 2007/146

(57) ABSTRACT

The disclosure relates to a device for supplying coolant to a processing device to be supplied with a fluid coolant. The processing device has at least two regions or tools to be cooled are integrated into an open or closed coolant circuit having a supply side and a return side. A reduced pressure generating unit (e.g., a vacuum generating unit) is located in the return side and the regions or tools to be cooled each have a supply side inlet and a return side outlet. A valve is arranged upstream of each supply side inlet and downstream of each return side outlet of the regions or tools to be cooled. The disclosure also relates to a cooling water system comprising such a device for supplying coolant; a coolant supply line; a coolant return line; a coolant supply valve; a coolant return valve; a signal transmitter; and a reduced pressure generating unit.

### BACKGROUND

### Technical Field

The disclosure relates to an apparatus for supplying coolant to a processing device which is intended to be supplied with fluid coolant, for example, a welding device.

### Description of the Related Art

Apparatuses for supplying coolant of the above type have been known in practice for years. They have a coolant supply side and a coolant return side. The coolant is pumped from the coolant supply side through tools which are intended to be cooled, for example, welding caps, up to the coolant return side. In this instance, the tools are cooled by the coolant.

When the tools are intended to be changed, the coolant circuit is first interrupted by means of two closure valves and subsequently a reduced pressure is produced in the coolant circuit. Such a reduced pressure may, for example, be produced by means of a suction cylinder with a volume adjustment, as known from DE 10 2019 204 208. Subsequently, the tools are removed from the coolant circuit. In order to activate the suction cylinder and/or the closure valves, a signal valve which is known, for example, from DE 10 2015 204 812 can be used.

The disadvantage of this construction is that, when a tool is removed, the reduced pressure in the entire coolant circuit collapses between the two closure valves. In this instance, cooling water can be discharged from the coolant circuit. Furthermore, the tools must be replaced in a specific sequence since otherwise even more cooling water can be discharged. In the case of a movement of the tools, as a result of vibrations a discharge of cooling water may also occur.

### BRIEF SUMMARY

Disclosed herein is an apparatus for supplying coolant of the type mentioned in the introduction in such a manner that, using structurally simple means, a discharge of cooling water is prevented or minimized.

Also disclosed herein is a cooling water system for such an apparatus.

According to the present disclosure, an apparatus for supplying coolant to a processing device which is intended to be supplied with fluid coolant, in particular water, for example, a welding device or a welding robot is provided, wherein the processing device has at least two regions or tools to be cooled, for example, welding caps, wherein the regions or the tools which are intended to be cooled are incorporated in an open or closed coolant circuit with a supply side and a in return side, wherein a reduced pressure generation unit is arranged in the return side and wherein the regions or the tools to be cooled each have a supply side inlet and a return side outlet, wherein a valve is arranged in each case before each supply side inlet and after each return side outlet of the regions or tools to be cooled.

The disclosure is further carried out by a cooling water system having an apparatus for supplying coolant as described herein, a coolant source, a coolant sink, a coolant supply side valve, a coolant return side valve, a signal transmitter, and a reduced pressure generation unit.

According to the disclosure, it has first been recognized that, as a result of a valve in front of and behind each tool to be cooled, the reduced pressure does not collapse in the entire coolant circuit, but instead only locally in the region of the tools. In this manner, an outlet of cooling water when the tools are changed can be prevented. Consequently, both tools can be changed at the same time and consequently more rapidly. Furthermore, a discharge of cooling water during a movement of the tools is thereby prevented.

According to an advantageous embodiment of the disclosure, the valves in front of the supply side inlet and after the return side outlet are in the form of non-return valves. As a result of the use of non-return valves, a collapse of the reduced pressure in the entire coolant circuit can be prevented in a simple manner. Furthermore, a reduced pressure which is produced is automatically transmitted through the entire coolant circuit. Furthermore, non-return valves can be integrated in a simple and cost-effective manner in an existing coolant circuit. Non-return valves are not very intensive in terms of structural space and require no external energy supply for activation. The non-return valves may in this instance be orientated in such a manner that they enable a flow of the coolant in the direction of the return side and prevent it in the direction of the supply side.

Preferably, the non-return valves have a minimum opening pressure of 0.01 bar, preferably 0.02 bar, in particular 0.05 bar. A small pump power of the coolant supply unit is thereby sufficient to activate the non-return valves. Consequently, a cost-effective pump can be used.

It is also possible for the valves in front of the supply side inlet and after the return side outlet to be able to be pneumatically, electrically, or hydraulically controlled. An advantage of this is that, in the event of an imminent change, the valves can already be closed beforehand. In this instance, a combination may also be possible, in which some valves are in the form of non-return valves and other valves are configured to be able to be actively controlled.

Advantageously, the coolant circuit can cool the regions or the tools to be cooled in a series arrangement. In this instance, the cooling water return side of a first tool is the cooling water supply side of a second tool. An advantage of this is that the cooling water circuit can be produced in a simple manner and the process monitoring can be carried out by way of a flow sensor in a manner less susceptible to malfunction.

In this instance, it is advantageous for a valve to be arranged at the same time in the return side outlet of a region or tool to be cooled and in the supply side inlet of another region or tool to be cooled. Since the return side of a first tool corresponds to the supply side of a second tool, a single valve can be used in order to fluidically separate the two tools from each other. An advantage of this is that fewer valves are required.

It is also possible for the coolant circuit to cool the regions or the tools to be cooled in a parallel arrangement. An advantage of this is that a plurality of tools can be connected directly to the cooling water supply side and the cooling water has not already been heated by a previous tool to be cooled. Furthermore, the hydraulic resistance by the parallel piping is less and a higher volume flow can be achieved with the same pressure relationships.

According to an advantageous further development of the disclosure, when the reduced pressure generation unit is activated, a reduced pressure may be produced in the coolant circuit in the supply side inlet and return side outlet of each of the regions or the tools to be cooled. An advantage of this is that only one reduced pressure generation unit is required to produce a reduced pressure in all the tools.

In particular, the reduced pressure generation unit may in this instance comprise a suction cylinder and/or a pump. The pump may, for example, be operated in an electric, pneumatic, or hydraulic manner. Furthermore, the pump may be integrated directly in the coolant circuit or provide reduced pressure by way of a bypass. The pump may, for example, comprise a Venturi nozzle or a jet pump.

### BRIEF DESCRIPTION OF THE SEVERAL VIEWS OF THE DRAWINGS

Now there are various possibilities for configuring and developing the teaching of the present disclosure in an advantageous manner. To this end, on the one hand, reference may be made to the claims and, on the other hand, to the following explanation of preferred exemplary embodiments of the disclosure with reference to the drawings. Together with the explanation of the preferred exemplary embodiments of the disclosure with reference to the drawings, generally preferred embodiments and further developments of the teaching are also explained. In the drawings:

FIG. 1 shows an overview of a cooling water system according to an embodiment of the present disclosure,

FIG. 2 shows a cooling water system for welding tongs according to an embodiment of the present disclosure,

FIG. 3a shows an apparatus for supplying coolant for welding tongs in a series arrangement according to an embodiment of the present disclosure,

FIG. 3b shows an apparatus for supplying coolant for welding tongs in a parallel arrangement according to an embodiment of the present disclosure,

FIG. 4 shows a flow path in a welding tong shaft according to an embodiment of the present disclosure.

### DETAILED DESCRIPTION

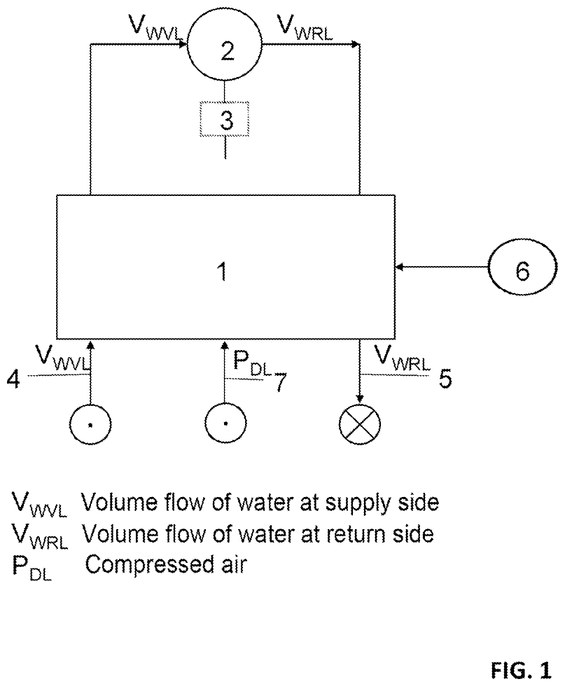

FIG. 1 shows an overview of a cooling water system for an automatic welding system. A basic device, in this instance in the form of a robot installation plate 1, acts as a center for the cooling water connections. By way of welding tongs 2, a workpiece 3 which is intended to be welded can be welded. As a result of the high temperatures produced during the welding operation, the welding tongs have to be cooled.

For cooling, cooling water is directed from a cooling water source 4 via the robot installation plate 1 to the welding tongs 2. The cooling water cools the welding tongs at that location and is subsequently directed back to a cooling water sink 5 via the robot installation plate. The control of the valves within the robot installation plate 1 is carried out via a signal transmitter 6. In order to activate the valves, compressed air which is supplied via a compressed air source 7 to the robot installation plate 1 is used.

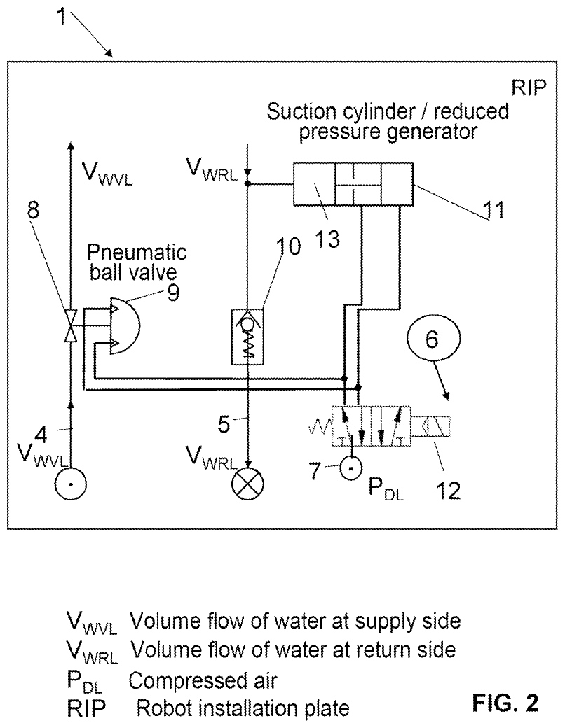

The robot installation plate 1 is explained in detail in FIG. 2.

Starting from the cooling water source 4, cooling water is directed to the welding tongs 2. The supply flow to the welding tongs 2 is controlled by way of a ball valve 8 which is activated by way of a pneumatic rotary drive 9. The ball valve 8 with the pneumatic rotary drive 9 may also be in the form of an electric or hydraulic valve. By way of the ball valve 8, the supply flow of cooling water can be stopped, for example, in the event of a welding cap loss, a cooling water hose bursting, a welding cap change or other process problems.

After the cooling water has cooled the welding tongs 2, it is diverted to the cooling water sink 5. In order to prevent a return flow of the cooling water to the welding tongs 2, a non-return valve 10 is arranged. The non-return valve 10 may also be in the form of an electric, pneumatic, or hydraulic valve.

Via a reduced pressure generation unit, in this instance in the form of a suction cylinder 11, with a closed ball valve 8 a reduced pressure can be produced in the coolant circuit. The suction cylinder 11 may be activated electrically, hydraulically, or pneumatically. It is also conceivable for the reduced pressure generation unit to be in the form of an electric, pneumatic, or hydraulic pump which pumps the cooling water out of the coolant circuit.

The ball valve 8 or the pneumatic rotary drive 9 and the suction cylinder 11 can be activated by way of compressed air. To this end, the compressed air source 7 is connected to the ball valve 9 and the suction cylinder 11 by way of a 5/2-way valve 12 which is controlled by way of the signal transmitter 6. In the first state of the directional control valve 12, the pneumatic rotary drive 9 is open and the suction cylinder 11 produces no reduced pressure. In the second state of the directional control valve 12, the ball valve 8 is closed and a piston of the suction cylinder 11 is moved inward so that in the active space 13 of the suction cylinder 11 a reduced pressure is produced. In this manner, a reduced pressure is produced at the same time as the valve 8 is closed. As a result of the closure of the ball valve 8 and the non-return valve 13, the reduced pressure is prevented from collapsing.

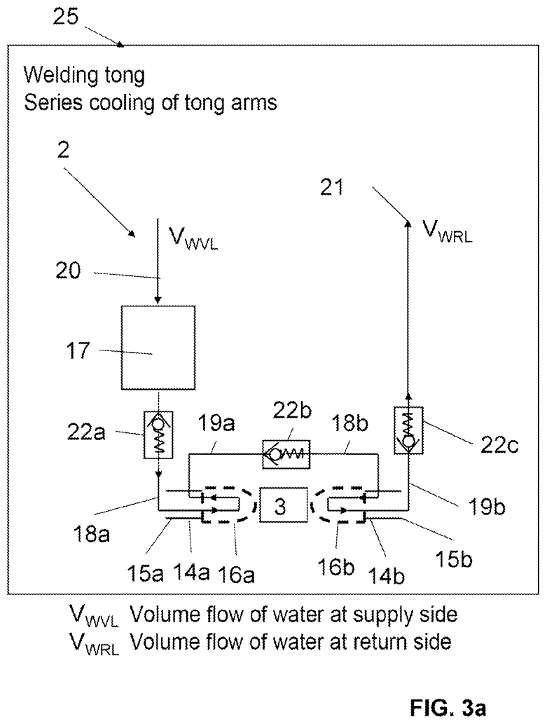

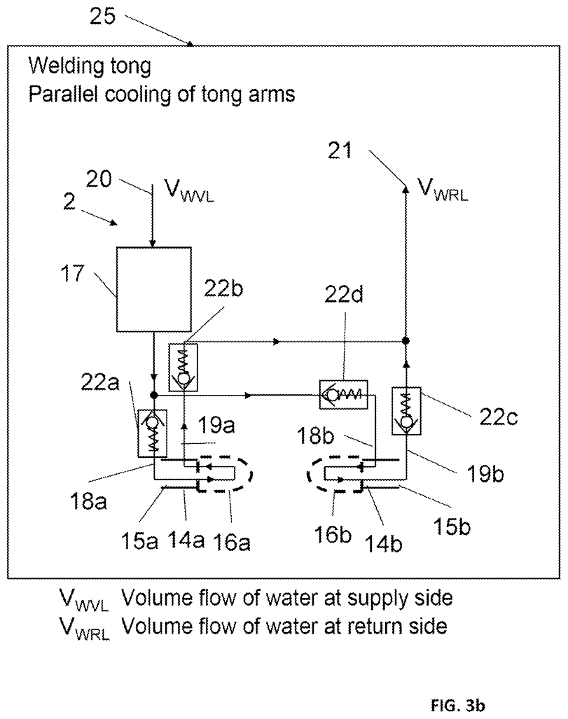

FIG. 3a shows an apparatus for supplying coolant for welding tongs in a series arrangement according to an embodiment of the present disclosure.

The welding tongs 2 comprise two tong arms 14a, 14b between which the workpiece 3 is arranged. The tong arms 14a, 144b comprise in each case a shaft 15a, 15b and a welding cap 16a, 16b. By way of the welding caps 16a, 16b which are releasably arranged on the tong arms 14a, 14b, the workpiece 6 can be welded. In this instance, the welding caps 16a, 16b have to be cooled. To this end, a coolant circuit is arranged in the apparatus 25 for supplying coolant.

The coolant flows from the coolant supply side 20 initially through a transformer 17. It is also conceivable for the transformer 17 to be cooled in a separate cooling circuit. The transformer 17 provides the required electrical energy for the welding operation. Subsequently, the coolant flows through the tong arms 14a, 14b, wherein the tong arms 14a, 14b are cooled in a series arrangement. The coolant flows initially through a supply side inlet 18a of the tong arms 14a and subsequently it is guided through a return side outlet 19a to the supply side inlet 18b of the additional tong arm 14b. Finally, it is returned through the return side outlet 19b of the additional tong arm 14b to the coolant return side 21. Via the coolant return side 21, the coolant is removed from the welding tongs 2.

The reduced pressure generation unit 11 is arranged in the return side 21. In order to change the welding caps 16a, 16b, the ball valve 8 is closed so that coolant can no longer flow into the welding tongs 2 and at the same time as a result of the reduced pressure generation unit 11 a reduced pressure is produced in order to pump cooling water from the welding tongs 2. However, as soon as one of the welding caps 16a, 16b is removed, the reduced pressure in both welding tongs 14a, 14b collapses. Cooling water can thereby be discharged, which can lead to corrosion of the workpiece 3 or other involved devices, such as, for example, automatic cap changers. Furthermore, cooling water puddles could lead to industrial accidents.

In order to prevent this, non-return valves 22a, 22b, 22c are in each case arranged in the supply side inlet 18a, 18b and return side outlet 19a, 19b. Since the return side outlet 19a of the first tong arms 14a corresponds to the supply side inlet 18b of the second tong arm 14b, in this instance only one non-return valve 22b is arranged here. As a result of the non-return valves 22a, 22b, 22c, a reduced pressure which is produced by the reduced pressure generation unit 11 is automatically transmitted into all the cooling water regions of the welding tongs 2. If one of the two welding caps 16a, 16b is removed, the reduced pressure collapses as a result of the non-return valves 22a, 22b, 22c in each case only in the respective tong arm 14a, 14b, but not in the entire coolant circuit. For example, when the welding cap 16b is removed, air flows into the tong arm 14b. The non-return valve 22b prevents the air from reaching the first tong arm 14a. As a result of the non-return valve 22c, cooling water is prevented from flowing out of the return side 21 into the welding tongs. If in contrast the welding cap 16a is removed, the non-return valve 22a prevents a throughflow of the air into the supply side 20. At the same time, the non-return valve 22b prevents the cooling water from flowing back out of the tong arm 14b and being discharged. In this manner, an outflow of cooling water is reduced or completely prevented. Furthermore, both welding caps 16a, 16b can be removed at the same time. Furthermore, as a result of movements of the welding tongs 2, system vibrations or pressure peaks are prevented by way of the non-return valves 22a, 22b, 22c from resulting in uncontrolled water movement which would lead to a cooling water discharge.

The non-return valves 22a, 22b, 22c are in this instance arranged close to the welding arms, in particular as close as structurally possible, so that as little cooling water as possible remains between the non-return valves 22a, 22b, 22c and within the tong arms 14a, 14b. The cooling water between the non-return valves 22a, 22b, 22c and the tong arms 14a, 14b can be moved by the suction cylinder 11 into the active space 13 of the suction cylinder. In particular, the active space 13 of the suction cylinder 11 can be adapted to the volume of the cooling water between the non-return valves 22a, 22b, 22c and the tong arms 14a, 14b.

FIG. 3b shows another configuration of the apparatus for supplying coolant.

In contrast to the apparatus for supplying coolant according to FIG. 3a, in the apparatus 25 for supplying coolant according to FIG. 3b the tong arms 14a, 14b of the welding tongs 2 are cooled in a parallel arrangement. The cooling water flows from the supply side 20 through the transformer 17 and is divided so that it flows in each case into the supply side inlet 18a, 18b of the tong arms 14a, 14b. Subsequently, it flows via the return side outlets 19a, 19b back into the return side 21. Accordingly, four non-return valves 22a, 22b, 22c 22d are arranged in each case in the supply side inlets 18a, 18b and return side outlets 19a, 19b so that a removal of a welding cap 16a, 16b leads only to a collapse of the reduced pressure in the respective tong arms 14a, 14b.

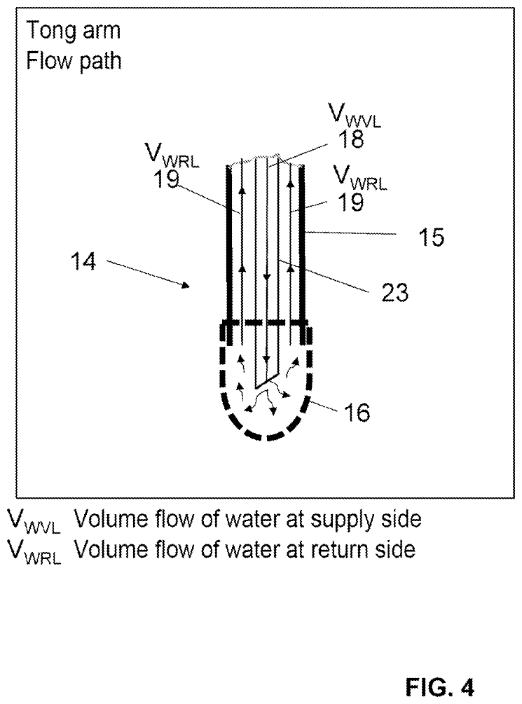

FIG. 4 shows a flow path in a welding tong shaft according to an embodiment of the present disclosure.

The tong arms 14 comprises the shaft 15, in this instance in the form of a welding tong shaft, and the welding cap 16. Via the supply side inlet 18, cooling water in an inner cooling pipe 23 is directed to the welding cap 16. There it cools the welding cap 16 and is subsequently pumped through the shaft 15 to the return side outlet 19.

With regard to additional advantageous embodiments of the apparatus according to the disclosure, in order to prevent repetition reference may be made to the general part of the description and the appended claims.

Finally, it should be expressly noted that the exemplary embodiments of the apparatus according to the disclosure as described above serve only to explain the claimed teaching, but do not limit this to the exemplary embodiments.

LIST OF REFERENCE NUMERALS

| | |
|---|---|
| 1 | Basic device |
| 2 | Welding tongs |
| 3 | Workpiece |
| 4 | Cooling water source |
| 5 | Cooling water sink |
| 6 | Signal transmitter |
| 7 | Compressed air source |
| 8 | Ball valve |
| 9 | Pneumatic rotary drive |
| 10 | Non-return valve |
| 11 | Suction cylinder |
| 12 | 5/2- way valve |
| 13 | Active space |
| 14 | Tong arm |
| 15 | Shaft |
| 16 | Welding cap |
| 17 | Transformer |
| 18 | Supply side inlet |
| 19 | Return side outlet |
| 20 | Coolant supply side |
| 21 | Coolant return side |
| 22 | Non-return valves |
| 23 | Inner cooling pipe |

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An apparatus for supplying coolant to a processing device to be supplied with a fluid coolant, wherein the processing device has at least two regions or tools to be cooled, the apparatus comprising:
an open or closed coolant circuit with a supply side and a return side, wherein the regions or tools to be cooled are incorporated in the open or closed coolant circuit;
a reduced pressure generation unit arranged in the return side, wherein the regions or tools to be cooled each have a supply side inlet and a return side outlet;
a valve arranged respectively before each supply side inlet and after each return side outlet of the regions or tools to be cooled,
wherein, when the reduced pressure generation unit is activated, a reduced pressure is produced in the coolant circuit in the supply side inlet and the return side outlet of each of the regions or the tools to be cooled, and
wherein the reduced pressure generating unit is arranged downstream of the valve in the direction of flow of the fluid coolant.

2. The apparatus as claimed in claim 1, wherein the valve in front of the supply side inlet and after the return side outlet of each of the regions or tools to be cooled is a non-return valve.

3. The apparatus as claimed in claim 2, wherein the non-return valve has a minimum opening pressure of 0.01 bar.

4. The apparatus as claimed in claim 1, wherein the valve in front of the supply side inlet and after the return side outlet of each of the regions or tools to be cooled is pneumatically, electrically, or hydraulically controlled.

5. The apparatus as claimed in claim 1, wherein the coolant circuit cools the regions or the tools to be cooled in a series arrangement.

6. The apparatus as claimed in claim 1, wherein a valve is arranged at the same time in the return side outlet of a region or tool to be cooled and in the supply side inlet of another region or tool to be cooled.

7. The apparatus as claimed in claim 1, wherein the coolant circuit cools the regions or the tools to be cooled in a parallel arrangement.

8. (canceled)

9. The apparatus as claimed in claim 1, wherein the reduced pressure generation unit comprises a suction cylinder or a pump.

10. A cooling water system having an apparatus for supplying coolant as claimed in claim 1, a coolant source, a coolant sink, a coolant supply side valve, a coolant return side valve, a signal transmitter and a reduced pressure generation unit.
